(19) United States
(12) Patent Application Publication
(10) Pub. No.: US 2025/0005352 A1
(43) Pub. Date: Jan. 2, 2025

(54) LEARNING DATA AUGMENTATION METHOD AND SYSTEM USING FREQUENCY DOMAIN

(71) Applicant: Gwangju Institute of Science and Technology, Gwangju (KR)

(72) Inventors: Ue Hwan KIM, Gwangju (KR); Ji Ae YOON, Gwangju (KR)

(73) Assignee: Gwangju Institute of Science and Technology, Gwangju (KR)

(21) Appl. No.: 18/596,963

(22) Filed: Mar. 6, 2024

(30) Foreign Application Priority Data
Jun. 29, 2023 (KR) 10-2023-0084519

(51) Int. Cl. G06N 3/08; G06T 7/90

(52) U.S. Cl. CPC G06N 3/08; G06T 7/90; G06T 2207/20081; G06T 2207/20084

(57) ABSTRACT

A learning data augmentation method is disclosed. According to the method, a learning target image is received, a frequency spectrum corresponding to the learning target image is obtained by applying frequency transformation to the learning target image, a plurality of sub-frequency spectra from the frequency spectrum is obtained by separating the frequency spectrum according to a plurality of preset frequency bands, and a learning data set is obtained by applying inverse frequency transformation to each of the plurality of obtained sub-frequency spectra.

### CROSS REFERENCE TO RELATED APPLICATION

The present application claims the priority to Korean Patent Application No. 10-2023-0084519, filed on Jun. 29, 2023, the entire contents of which is incorporated herein by reference for all purposes.

### BACKGROUND

### Field

The present invention relates to a learning data augmentation method and system using a frequency domain.

### Description of the Related Art

With the advancement of an artificial intelligence technology, an artificial neural network has been actively researched to distinguish types of the objects included in images or classify the images according to various features. This artificial neural network generally outputs more accurate results as an amount of data used for learning the artificial neural network increases.

However, as the purpose of using the artificial neural network becomes more advanced, a difficulty arises in the process of collecting the data to learn the artificial neural network. For this purpose, a conventional method has developed techniques that generate fake learning data using a noise, learn the artificial neural network using as much learning data as possible, and additionally learn the artificial neural network using the data acquired in the process of using the artificial neural network.

In this regard, the FSCIL (Few-Shot Class Incremental Learning) artificial neural network consists of a base session and an incremental session, wherein the basic session performs learning on an extractor that extracts features from data and a classifier that classifies the data based on the features, and the incremental session performs learning on the classifier based on the features extracted from the data.

Such FSCIL-typed artificial neural network includes CEC (Continuously Evolved classifiers), FACT (Forward Compatible Few-Shot Class Incremental Learning), and FeSSSS (Few-Shot Self-Supervised System).

However, despite of this effort, it is still difficult to collect an amount of data required to learn the artificial neural network.

### SUMMARY

The present invention relates to a learning data augmentation method and system for augmenting a plurality of images required for learning an artificial neural network.

Further, the present invention is directed to a learning data augmentation method and system for dividing one image into a plurality of images having different features through frequency transformation of the image.

In order to solve the problems as described above, a learning data augmentation method according to the present invention may comprise the steps of: receiving a learning target image; obtaining a frequency spectrum corresponding to the learning target image by applying frequency transformation to the learning target image; obtaining a plurality of sub-frequency spectra from the frequency spectrum by separating the frequency spectrum according to a plurality of preset frequency bands; and obtaining a learning data set by applying inverse frequency transformation to each of the plurality of obtained sub-frequency spectra.

Further, a learning data augmentation system according to the present invention may comprise a storage unit that stores a learning target image; and a control unit that applies frequency transformation to the learning target image to obtain a frequency spectrum corresponding to the learning target image, separates the frequency spectrum according to a plurality of preset frequency bands to obtain a plurality of sub-frequency spectra from the frequency spectrum, and obtains a learning data set by applying inverse frequency transformation to each of the plurality of obtained sub-frequency spectra.

Furthermore, a program stored in a computer-readable recording medium according to the present invention is executed by one or more processes in an electronic device, and may comprise instructions that cause the following steps to be performed: receiving a learning target image; obtaining a frequency spectrum corresponding to the learning target image by applying frequency transformation to the learning target image; obtaining a plurality of sub-frequency spectra from the frequency spectrum by separating the frequency spectrum according to a plurality of preset frequency bands; and obtaining a learning data set by applying inverse frequency transformation to each of the plurality of obtained sub-frequency spectra.

According to various embodiments of the present invention, the learning data augmentation method and system can generate a learning data set containing a plurality of learning images based on one learning target image, thereby augmenting a large number of learning data required for learning an artificial neural network, and through this, learning the artificial neural network with higher efficiency using a small number of learning data.

In particular, the learning data augmentation method and system according to the present invention can be implemented to enable more efficient learning by augmenting a small number of learning data input to the artificial neural network in relation to an incremental session for a FSCIL-typed artificial neural network.

In addition, according to various embodiments of the present invention, the learning data augmentation method and system can extract a plurality of images different from each other in at least one of a color element and a frequency band from one learning target image through frequency transformation, and perform inverse frequency transformation to generate a plurality of learning images with different features.

### BRIEF DESCRIPTION OF THE DRAWINGS

FIG. 1 shows a learning data augmentation system according to the present invention.

FIG. 2 shows an embodiment of an artificial neural network to which the learning data augmentation system according to the present invention is applied.

FIG. 3 is a flowchart showing a method for augmenting learning data according to the present invention.

FIGS. 4 to 6 show an embodiment of generating a frequency spectrum based on a learning target image.

FIG. 7 shows an embodiment of generating a sub-channel frequency spectrum from a frequency spectrum.

FIGS. 8 and 9 show an embodiment of generating a learning image from a frequency spectrum.

FIG. 10 shows an embodiment of a learning data augmentation process.

FIGS. 11 to 13 are graphs showing an embodiment of the learning results of an artificial neural network to which a learning data augmentation method according to the present invention is applied.

### DETAILED DESCRIPTION

Hereinafter, embodiments disclosed in this specification will be described in detail with reference to the attached drawings. However, the same or similar constitutive elements will be assigned the same reference numbers regardless of the drawing symbols, and duplicate descriptions thereof will be omitted. The suffixes “module” and “unit” for the constitutive elements used in the following description are given or used interchangeably only for the ease of preparing the specification, and do not have distinct meanings or roles by themselves. Also, in explaining the embodiments disclosed in this specification, if it is determined that detailed description of related known technology may obscure the gist of the embodiments disclosed in this specification, the detailed description thereof will be omitted. In addition, since the attached drawings are only for easy understanding of the embodiments disclosed in this specification, it should be understood that the technical idea disclosed in this specification is not limited by the attached drawings, and that the attached drawings include all modifications, equivalents, and substituents fallen within in the spirit and the technical scope of the present invention.

The terms containing ordinal numbers such as first, second, etc., may be used to explain various constitutive elements, but these constitutive elements are not limited by said terms. The terms are used only for the purpose of distinguishing one constitutive element from other constitutive element.

In case a certain constitutive elements are said to be “joined” or “connected” to other constitutive element, it should be understood that it may be directly joined to or connected to the other constitutive element, but that another constitutive element may exist between them. On the other hand, in case a certain constitutive element is said to be “directly joined” or “directly connected” to other constitutive element, it should be understood that there are no other constitutive elements between them.

A singular expression includes a plural expression unless the context clearly dictates otherwise.

It should be understood that, in the subject application, the term such as “comprise” or “have” is intended to designate the presence of features, numbers, steps, motions, constitutive elements, parts, or combinations thereof described in the specification, without precluding the presence or addition of one or more other features, numbers, steps, motions, constitutive elements, parts or combinations thereof.

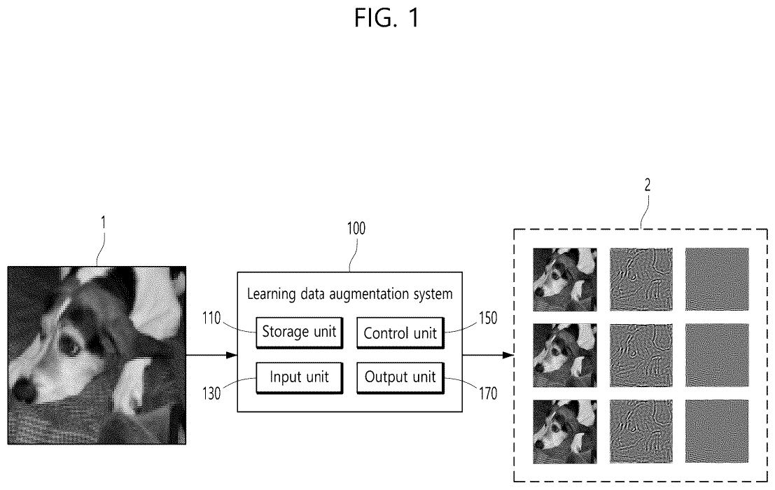

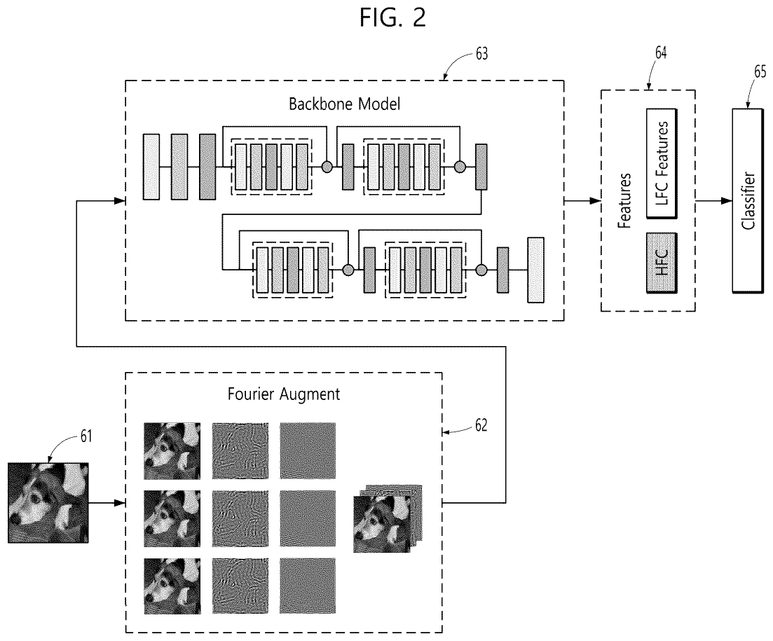

FIG. 1 shows a learning data augmentation system according to the present invention. FIG. 2 shows an embodiment of an artificial neural network to which the learning data augmentation system according to the present invention is applied.

Referring to FIG. 1, if the learning data augmentation system 100 according to the present invention receives a learning target image 1, it can generate a frequency spectrum by applying frequency transformation to the learning target image 1, and generate a plurality of sub-frequency spectra by separating the frequency spectrum according to different frequency bands.

Accordingly, the learning data augmentation system 100 may apply inverse frequency transformation to the generated plurality of frequency spectra to generate a learning data set 2, and input the generated learning data set 2 into an artificial neural network.

Herein, the learning target image 1 may be an image input for learning the artificial neural network. Accordingly, the learning target image 1 may be matched with data required for learning of the artificial neural network.

For example, in case the learning target image 1 is an image for learning the artificial neural network implemented with a CNN (Convolution Neural Network) method, a label data, which is correct answer data for the learning target image 1, may be labeled and input. In this case, the label data may be set to various forms of data such as a text, a number, and a symbol.

The frequency spectrum may be an image generated through frequency transformation (for example, Discrete Fourier Transform (DFT)) on the learning target image. Therefore, the frequency spectrum may be an image in which a frequency according to change in a color between adjacent pixels among a plurality of pixels included in the learning target image is listed.

In this case, the frequency spectrum may appear as a pixel value with a lower frequency value for a pixel point in the image as the pixel is closer to the pixel point, and appear as a pixel value with a higher frequency value for a pixel point in the image as the pixel is farther away from the pixel point. For example, in the frequency spectrum, the frequency value of a center pixel may be set to 0, so that the lower frequency value may appear as the pixel value as it gets closer to the center pixel, and the higher frequency value may appear as the pixel value as it moves away from the center pixel.

The sub-frequency spectrum may be an image from which pixels corresponding from a preset first frequency value to a second frequency value different from the first frequency value are extracted in the frequency spectrum. That is, the sub-frequency spectrum may be an image from which at least some area of the frequency spectrum is extracted, and may be an image in which a frequency value corresponding to at least some band among entire frequency bands appearing in the frequency spectrum are indicated.

In this regard, the learning data augmentation system 100 may further generate at least one of a channel frequency spectrum and a sub-channel frequency spectrum using the learning target image 1.

To this end, the learning data augmentation system 100 may generate at least one of the channel frequency spectrum and the sub-channel frequency spectrum by extracting pixel values corresponding to color elements from the learning target image (or frequency spectrum).

Accordingly, the channel frequency spectrum may be a frequency spectrum containing pixel values extracted for each color element (e.g., Red-Green-Blue). Also, the sub-channel frequency spectrum may be a frequency spectrum containing the color elements and the pixel values extracted for each frequency band.

Meanwhile, the learning data set 2 may include data generated to learn the artificial neural network. That is, the learning data set 2 may include a plurality of learning images obtained through inverse frequency transformation (e.g., inverse discrete Fourier transform (IDFT)) for the frequency spectrum.

In this case, the learning data set 2 may be created as data of a three-dimensional form, which may be data in which each learning image with a height and width is arranged in a plurality of channels (or depths).

Through this, the learning data augmentation system 100 may learn the artificial neural network by inputting the learning data set 2 to a pre-prepared artificial neural network.

In this case, the artificial neural network may refer to conventionally known various artificial neural networks that use an image. For example, the artificial neural network may refer to various means of the artificial neural networks that involve a process of extracting feature data from the image, such as a supervised learning, an unsupervised learning, and a reinforcement learning.

As another example, the artificial neural network may refer to a FSCIL-typed artificial neural network such as CEC, FACT, and FeSSSS.

As described above, the learning data augmentation system 100 according to the present invention may generate a learning data set 2 containing a plurality of learning images based on one learning target image 1, thereby providing a large number of learning data required for learning the artificial neural network, through which the learning data augmentation system 100 can learn the artificial neural network with high efficiency.

In particular, the learning data augmentation system 100 according to the present invention may be implemented to enable more efficient learning by augmenting a small number of data input to the artificial neural network in relation to an incremental session for the FSCIL-typed artificial neural network.

According to an embodiment, the learning data augmentation system 100 as described above may be configured separately from the artificial neural network to process a learning image to be input to the artificial neural network, or may be included in the artificial neural network. In this case, if the learning target image is input, the artificial neural network generates a learning data set from the learning target image through the learning data augmentation system 100, and may have an extractor that extracts feature data from the learning data set and a classifier that classifies the feature data to generate correct answer data.

For example, with reference to FIG. 2, the learning data augmentation system 100 may generate a learning data set 62 based on the learning target image 61, and input the generated learning data set 62 into the artificial neural network. That is, the learning data augmentation system 100 is connected to an input terminal of a Backbone Model 63 included in the artificial neural network, thereby generating the learning data set 62 from the learning target image 61, extracting feature data 64 of a high frequency component (HFC) and a low frequency component (LFC) of the generated learning data set 62 through the Backbone Model 63, and inputting the extracted feature data 64 into the classifier 65 to acquire output of the artificial neural network.

At this time, in order to improve efficiency and accuracy of learning the artificial neural network, some hidden layers (or convolution layers) of the Backbone Model 63 included in the artificial neural network may be replaced with the learning data augmentation system 100 according to the present invention.

In this case, in the artificial neural network, at least one hidden layer included to transform the learning target image into 3-dimensional data through channel division for the learning target image may be replaced with a layer that acquires the learning data set from the learning target image by the learning data augmentation method according to the present invention.

Referring again to FIG. 1, the learning data augmentation system 100 according to the present invention may comprise a storage unit 110, an input unit 130, a control unit 150, and an output unit 170.

The storage unit 110 may store data and instructions necessary for operation of the learning data augmentation system 100 according to the present invention.

For example, the storage unit 110 may store a learning target image 1 and a learning data set 2, and further store various images produced in the process of generating the learning data set 2 based on the learning target image 1.

As another example, the storage unit 110 may store instructions implemented to perform frequency transformation and inverse infrequency transformation on the image, and may further store instructions implemented to process each image.

The input unit 130 may be configured to connect to the other device and the input equipment through a wireless or wired network to receive data. Accordingly, the control unit 150 may input (or receive) the learning target image 1 from the outside through the input unit 130.

The control unit 150 may control overall operation of the learning data augmentation system 100 according to the present invention. For example, in case the learning target image 1 is input, the control unit 150 may perform frequency transformation on the learning target image 1 and separate the transformed frequency spectrum into a plurality of frequency bands to generate a plurality of sub-frequency spectra.

Further, the control unit 150 may generate the learning data set 2 by performing inverse frequency transformation on the frequency spectra (e.g., sub-frequency spectrum, sub-channel frequency spectrum), and learn the artificial neural network using the generated learning data set 2.

In this case, the fact that the control unit 150 learns the artificial neural network may mean inputting the learning data set 2 to a pre-prepared artificial neural network through the output unit 170.

The output unit 170 may be connected to the other device and the input equipment through a wireless or wired network to transmit data. Accordingly, the control unit 150 may output the learning data set 2 to the outside through the output unit 170.

Based on the configuration of the learning data augmentation system 100 as discussed above, a learning data augmentation method will be described in more detail below.

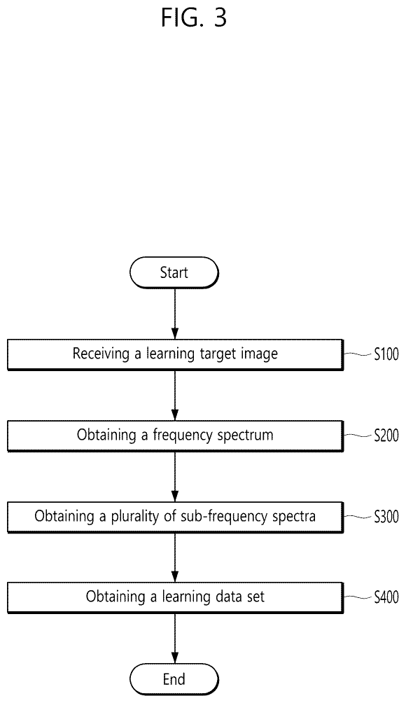

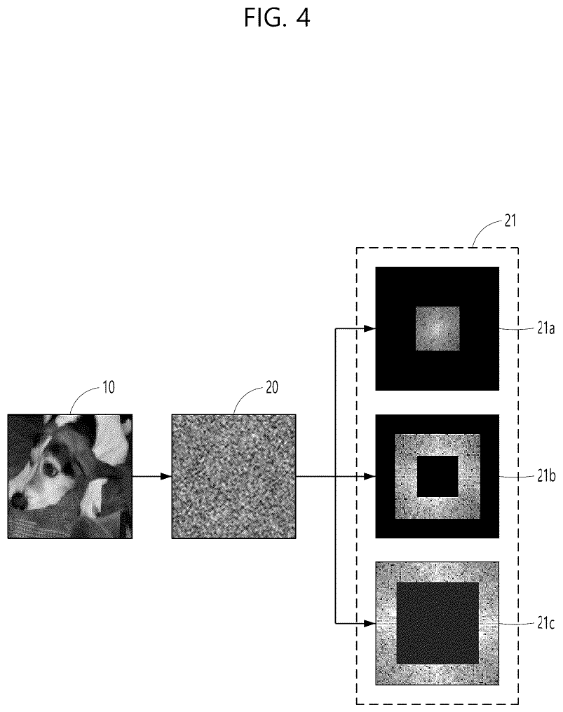

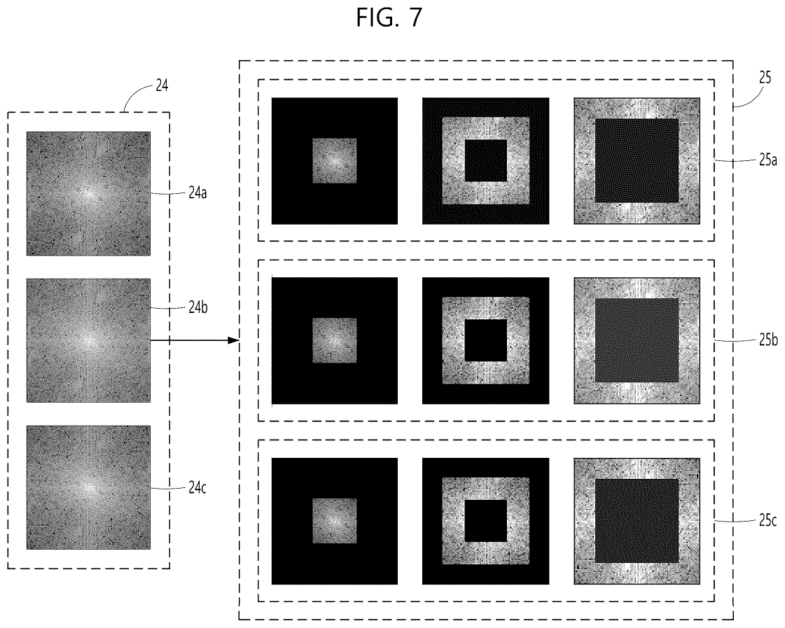

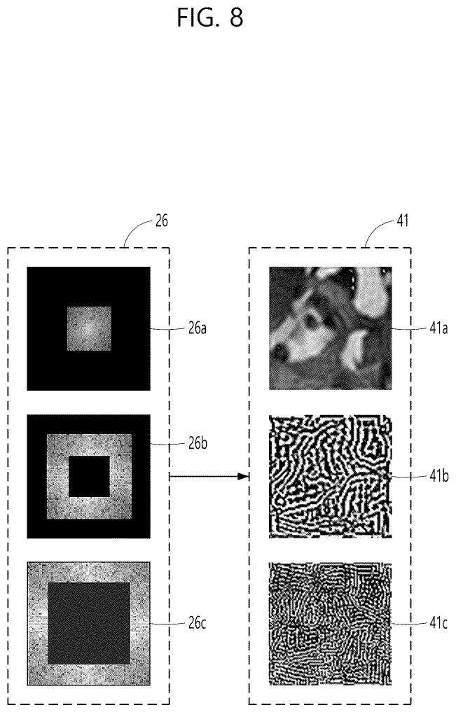

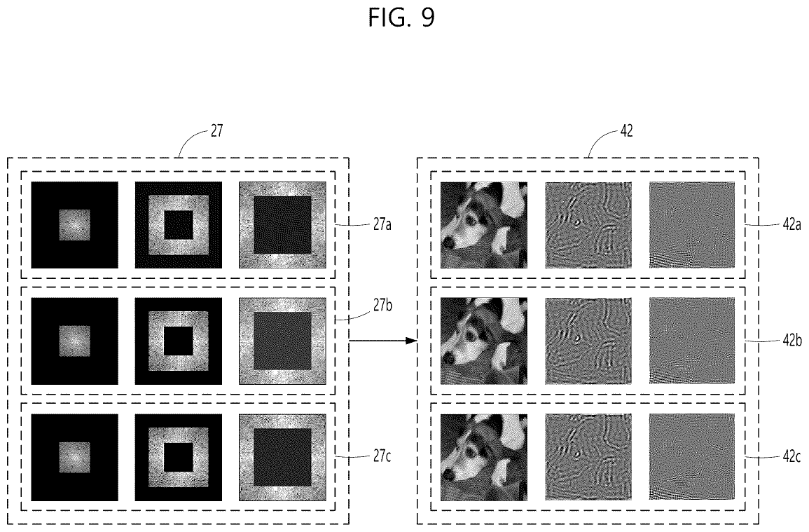

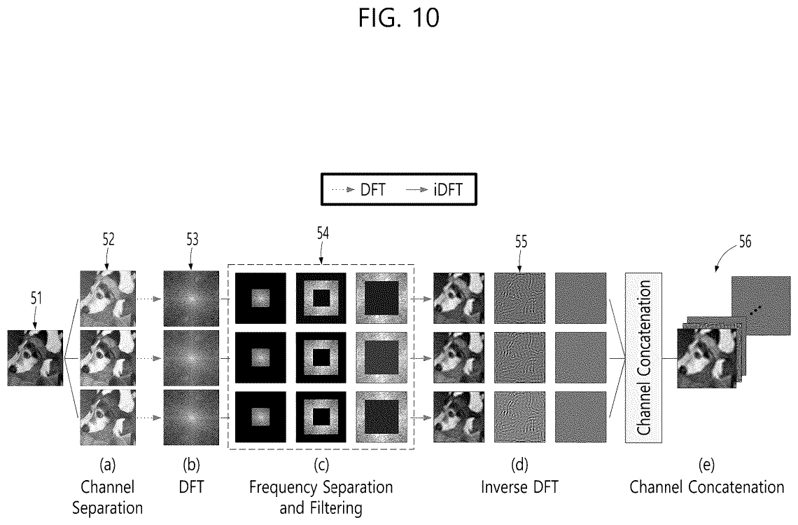

FIG. 3 is a flowchart showing a learning data augmentation method according to the present invention. FIGS. 4 to 6 show an embodiment of generating a frequency spectrum based on a learning target image. FIG. 7 shows an embodiment of generating a sub-channel frequency spectrum from the frequency spectrum. FIGS. 8 and 9 show an embodiment of generating learning a learning image from the frequency spectrum. FIG. 10 shows an embodiment of a learning data augmentation process.

Referring to FIG. 3, in case the learning data augmentation system 100 according to the present invention receives a learning target image 1, it can acquire a frequency spectrum corresponding to the learning target image by applying frequency transformation to the learning target image (S100), and acquire a plurality of sub-frequency spectra from the frequency spectrum by separating the frequency spectrum according to a plurality of preset frequency bands (S200).

For example, in case the learning data augmentation system 100 receives the learning target image, it can perform frequency transformation on the learning target image to acquire the frequency spectrum expressing a frequency band corresponding to the learning target image.

For example, the learning data augmentation system 100 may obtain the frequency spectrum corresponding to the learning target image through a Fourier transform (or a Discrete Fourier transform).

Furthermore, the learning data augmentation system 100 may acquire a plurality of sub-frequency spectra by extracting an image area corresponding to each of a plurality of preset frequency bands from the frequency spectrum.

For example, the learning data augmentation system 100 may be set, as a plurality of frequency bands, with a first frequency band from a first frequency to a second frequency and a second frequency band from a third frequency to a fourth frequency.

In this case, the first frequency may be a highest value among a plurality of pixel values appearing in the frequency spectrum, and the second frequency may be a value immediately following a pixel value corresponding to the third frequency among the plurality of pixel values appearing in the frequency spectrum. The third frequency may be a value immediately before a pixel value corresponding to the second frequency among the plurality of pixel values appearing in the frequency spectrum, and the fourth frequency may be a lowest value among the plurality of pixel values appearing in the frequency spectrum. That is, the second frequency may be the lowest value among the values higher than the third frequency among the plurality of frequencies appearing in the frequency spectrum, and the third frequency may be the highest value among the values lower than the second frequency among the plurality of frequencies appearing in the frequency spectrum.

In this case, the learning data augmentation system 100 may acquire a first sub-frequency spectrum and a second sub-frequency spectrum by extracting a first image area corresponding to the first frequency band from the frequency spectrum and a second image area corresponding to the second frequency band from the frequency spectrum.

Herein, the first sub-frequency spectrum may be an image extracted from the frequency spectrum corresponding to the first image area, and the second sub-frequency spectrum may be an image extracted from the frequency spectrum corresponding to the second image area.

Accordingly, the first sub-frequency spectrum and the second sub-frequency spectrum may be images in which different non-overlapping areas are extracted from the frequency spectrum. That is, the first sub-frequency spectrum may be an image excluding the second sub-frequency spectrum from the frequency spectrum, and the second sub-frequency spectrum may be an image excluding the first sub-frequency spectrum from the frequency spectrum.

However, in case there is an overlapping frequency in the first frequency band and the second frequency band, some overlapping areas may exist in the first sub-frequency spectrum and the second sub-frequency spectrum.

Also, the first frequency band and the second frequency band may be set to correspond to a preset frequency band, or each of the frequency bands may be set based on a preset ratio (for example, each ratio of 1/3) to the entire frequency area appearing in the frequency spectrum.

As another example with reference to FIG. 4, the learning data augmentation system 100 may extract a plurality of sub-frequency spectra 21 corresponding to a plurality of image areas preset to a predetermined size, respectively, from the frequency spectrum 20. That is, the learning data augmentation system 100 may extract from the frequency spectrum 20, a first sub-frequency spectrum 21a corresponding to a first image area, a second sub-frequency spectrum 21b corresponding to a second image area, and a third sub-frequency spectrum 21c corresponding to a third image area.

In this case, the first image area, the second image area, and the third image area may be set as divided areas, respectively, based on a preset ratio for one side of the frequency spectrum 20. Alternatively, the first image area, the second image area, and the third image area may be set as divided areas, respectively, based on a preset ratio to an area of the frequency spectrum 20.

That is, each image area may be set to extract an image area corresponding to the frequency band that is intended to extract from the frequency spectrum 20, wherein the image area may be set based on a point (for example, a center point) indicating the lowest frequency in the frequency spectrum 20.

In this regard, the learning data augmentation system 100 may acquire a plurality of sub-frequency spectra from one frequency spectrum. In an embodiment, the learning data augmentation system 100 may acquire three sub-frequency spectra divided into a low frequency band, a middle frequency band, and a high frequency band from the frequency spectrum. However, since the number of the plurality of sub-frequency spectra obtained from the frequency spectrum is not limited to the above embodiment, the learning data augmentation system 100 according to the present invention can acquire various numbers of the sub-frequency spectra from the frequency spectrum.

Furthermore, the learning data augmentation system 100 may acquire a plurality of channel images from a learning target image (or frequency spectrum) by separating the learning target image (or frequency spectrum) into a plurality of channels according to a plurality of preset color elements.

That is, the learning data augmentation system 100 may acquire a plurality of channel images (or a plurality of channel frequency spectra) by extracting pixel values corresponding to each of the plurality of preset color elements from each pixel of the learning target image (or frequency spectrum).

In this case, extracting the pixel values corresponding to the preset color elements from the pixels may mean extracting values corresponding to the preset color elements among the values related to a plurality of color elements corresponding to the pixel values. In an embodiment, in case a value of any one pixel included in a RGB image is #F3F320, the values associated with the plurality of color elements corresponding to the pixel may be R-243, G-243, and B-32. Therefore, in the above pixel, a pixel value corresponding to the R element may be 243, a pixel value corresponding to the G element may be 243, and a pixel value corresponding to the B element may be 32.

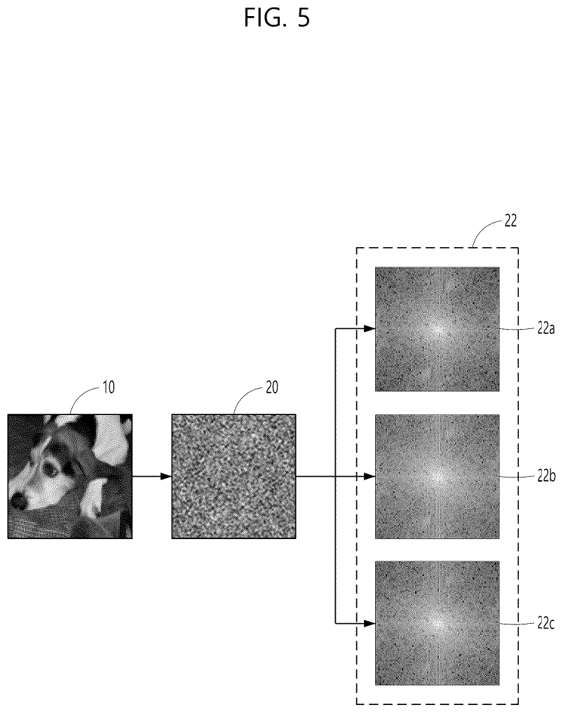

Meanwhile, for example, referring to FIG. 5, the learning data augmentation system 100 may acquire a frequency spectrum 20 through frequency transformation for a learning target image 10, and acquire a plurality of channel frequency spectra 22 by extracting pixel values corresponding to each of a plurality of preset color elements at each pixel of the frequency spectrum 20.

That is, the learning data augmentation system 100 may acquire a first channel frequency spectrum 22a corresponding to a first color element, a second channel frequency spectrum 22b corresponding to a second color element, and a third channel frequency spectrum 22c corresponding to a third color element from the frequency spectrum 20.

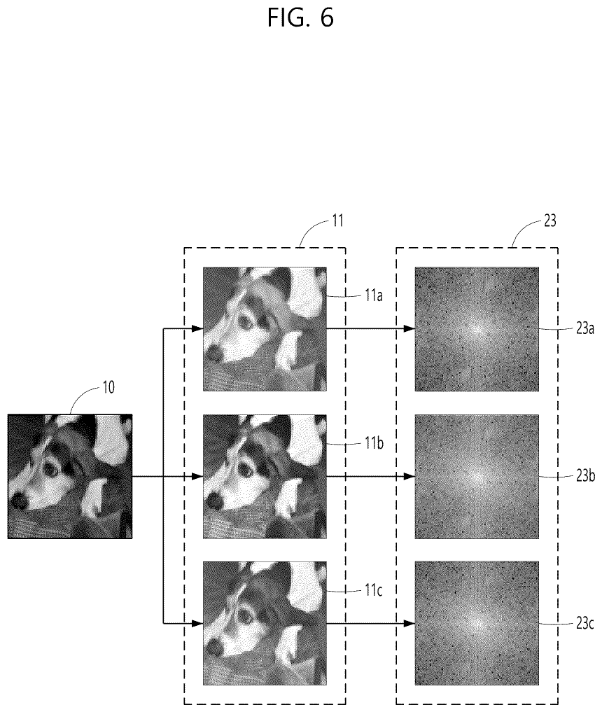

As another example with reference to FIG. 6, the learning data augmentation system 100 may acquire a plurality of channel images 11 by extracting pixel values corresponding to each of a plurality of preset color elements from each pixel of a learning target image 10.

That is, the learning data augmentation system 100 may acquire a first channel image 11a corresponding to a first color element (e.g., Red), a second channel image 11b corresponding to a second color element (e.g., Green), and a third channel image 11c corresponding to a third color element (e.g., Blue) from the learning target image 10.

In this case, the learning data augmentation system 100 may acquire a plurality of channel frequency spectra 23 through frequency transformation for each channel image 11. That is, the learning data augmentation system 100 may acquire a first channel frequency spectrum 23a from a first channel image 11a, a second channel frequency spectrum 23b from a second channel image 11b, and a third channel frequency spectrum 23c from a third channel image 11c, through the frequency transformation.

In this regard, the learning data augmentation system 100 may acquire a plurality of channel images (or channel frequency spectra) from one learning target image (or frequency spectrum). In an embodiment, the learning data augmentation system 100 may obtain three channel images divided into a R element, a G element, and a B element from the learning target image based on RGB (Red-Green-Blue). However, the plurality of channel images (or channel frequency spectra) obtained from the learning target image (or frequency spectrum) are not limited to the above embodiments, and the learning data augmentation system 100 according to the present invention may acquire the channel images (or channel frequency spectra) based on various color elements (e.g., HSV (Hue-Saturation-Value), CMYK (Cyan-Magenta-Yellow-Key (Black)), Lab, YUV, etc.) obtained from the learning target image (or frequency spectrum).

Furthermore, the learning data augmentation system 100 may acquire a plurality of sub-channel frequency spectra from each of the plurality of channel frequency spectra by separating each of the plurality of channel frequency spectra according to a plurality of preset frequency bands.

That is, the learning data augmentation system 100 may obtain the plurality of sub-channel frequency spectra by extracting an image area corresponding to each of the plurality of preset frequency bands from each of the plurality of channel frequency spectra.

For example, with reference to FIG. 7, the learning data augmentation system 100 may extract a plurality of sub-channel frequency spectra 25 corresponding to a plurality of image areas preset to a predetermined size, respectively, from each of a plurality of channel frequency spectra 24.

That is, the learning data augmentation system 100 may extract a plurality of first sub-channel frequency spectra 25a corresponding to each of a first image area, a second image area, and a third image area from a first channel frequency spectrum 24a, extract a plurality of second sub-channel frequency spectra 25b corresponding to each of the first image area, the second image area, and the third image area from a second channel frequency spectrum 24b, and extract a plurality of a third sub-channel frequency spectra 25c corresponding to each of the first image area, the second image area, and the third image from a third channel frequency spectrum 24c.

As another example, the learning data augmentation system 100 may extract a plurality of the sub-channel frequency spectra 25 corresponding to each of a plurality of frequency bands preset to a predetermined band width from each of the plurality of channel frequency spectra 24.

That is, the learning data augmentation system 100 may extract a plurality of first sub-channel frequency spectra 25a corresponding to each of a first frequency band, a second frequency band, and a third frequency band from the first channel frequency spectrum 24a, extract a plurality of second sub-channel frequency spectra 25b corresponding to each of the first frequency band, the second frequency band, and the third frequency band from the second channel frequency spectrum 24b, and extract a plurality of third sub-channel frequency spectra 25c corresponding to each of the first frequency band, the second frequency band, and the third frequency band from the third channel frequency spectrum 24c.

Through the above configurations, the learning data augmentation system 100 according to the present invention can acquire a plurality of frequency spectra different from each other in at least one of the color elements and the frequency bands from one learning target image.

In an embodiment, the learning data augmentation system 100 may acquire different nine sub-channel frequency spectra by extracting a plurality of sub-channel frequency spectra in which at least one of the color elements and the frequency bands is different from each other, from one learning target image, based on three color elements (e.g., RGB) and three frequency bands (e.g., a low frequency band, a middle frequency band, and a high frequency band).

Referring again to FIG. 3, the learning data augmentation system 100 according to the present invention can obtain a learning data set by applying inverse frequency transformation to each of a plurality of sub-frequency spectra (S300).

For example, the learning data augmentation system 100 may apply inverse frequency transformation to each of the plurality of sub-frequency spectra to obtain a plurality of learning images from each of the plurality of sub-frequency spectra.

For example, with reference to FIG. 8, the learning data augmentation system 100 may transform each of a plurality of sub-frequency spectra 26 into a learning image 41 through inverse Fourier transform (or discrete inverse Fourier transform).

That is, the learning data augmentation system 100 may transform a first sub-frequency spectrum 26a into a first learning image 41a, transform a second sub-frequency spectrum 26b into a second learning image 41b, and transform a third sub-frequency spectrum 26c into a third learning image 41c, through inverse frequency transformation.

As another example, the learning data augmentation system 100 may transform each of the plurality of channel frequency spectra into the learning image through the inverse frequency transformation.

As another example with reference to FIG. 9, the learning data augmentation system 100 may transform each of a plurality of sub-channel frequency spectra 27 into a learning image 42 through inverse frequency transformation.

That is, the learning data augmentation system 100 may transform each of a plurality of first sub-channel frequency spectra 27a into a plurality of first learning images 42a, transform each of a second sub-channel frequency spectra 27b into a plurality of second learning images 42b, and transform each of third sub-channel frequency spectra 27c into a plurality of third learning images 42c.

Through the above configurations, the learning data augmentation system 100 according to the present invention can generate a plurality of learning images divided according to different features in the learning target image by performing inverse frequency transformation on each of the plurality of frequency spectra divided from one learning target image.

In this regard, since the learning data augmentation system 100 according to the present invention generates the plurality of learning images in which different features are extracted from one image through Fourier transform and inverse Fourier transform, it may also be called a Fourier incremental system.

In an embodiment, the learning data augmentation system 100 may acquire nine sub-channel frequency spectra from one learning target image, and perform inverse frequency transformation on each of the acquired nine sub-channel frequency spectra to acquire nine learning images that are different in at least one of the color elements and the frequency bands.

Furthermore, the learning data augmentation system 100 may generate a learning data set to include a plurality of learning images based on at least one of the learning target image and the plurality of learning images.

In other words, the learning data augmentation system 100 may generate the learning data set in which each of the plurality of learning images consists of one channel based on at least one of the learning target image and the plurality of learning images.

For example, with reference to FIG. 10, the learning data augmentation system 100 may generate a plurality of channel images 52 from a learning target image 51 and perform frequency transformation on each of the channel images 52 to create a plurality of channel frequency spectra 53, and separate each of the channel frequency spectra 53 into each frequency band to generate a plurality of sub-channel frequency spectra 54.

Accordingly, the learning data augmentation system 100 may generate a plurality of learning images 55 by performing inverse frequency transformation on each of the plurality of sub-channel frequency spectra 54 and connect each of the learning images 55 by each channel, thereby generating a learning data set 56 which has the same channel number as that of the plurality of learning images 55.

As another example, the learning data augmentation system 100 may connect each of the plurality of learning images in the form of two-dimensional data to create the learning data set in the form of three-dimensional data.

Furthermore, if there is label data matched to the learning target image, the learning data augmentation system 100 may match the label data matched to the learning target image, to the learning data set.

For example, in case the learning target image is labeled with a text “dog” as the label data, the learning data augmentation system 100 may label the learning data set with the text “dog” as the label data.

Through the above configurations, the learning data augmentation system 100 according to the present invention can match data required for learning of an artificial neural network to the learning data set through the learning target image.

Furthermore, the learning data augmentation system 100 according to the present invention may input the learning data set into the artificial neural network. In this case, when the learning data augmentation system 100 is equipped with the artificial neural network, it can input the learning data set to an extractor included in the artificial neural network.

Further, according to an embodiment, the learning data augmentation system 100 may learn the artificial neural network by inputting the learning data set 2 to a pre-prepared artificial neural network.

To this end, the learning data augmentation system 100 may be configured to learn the artificial neural network by comparing label data matched to the learning data set 2 and output of the artificial neural network according to the learning data set 2.

According to the above configurations, the learning data augmentation system 100 according to the present invention may generate the learning data set 2 containing the plurality of learning images and input it to the artificial neural network, based on one learning target image.

Through this, the learning data augmentation system 100 can generate a large number of the learning data required for learning the artificial neural network from a small number of the learning data, which can help increase a learning rate of the artificial neural network.

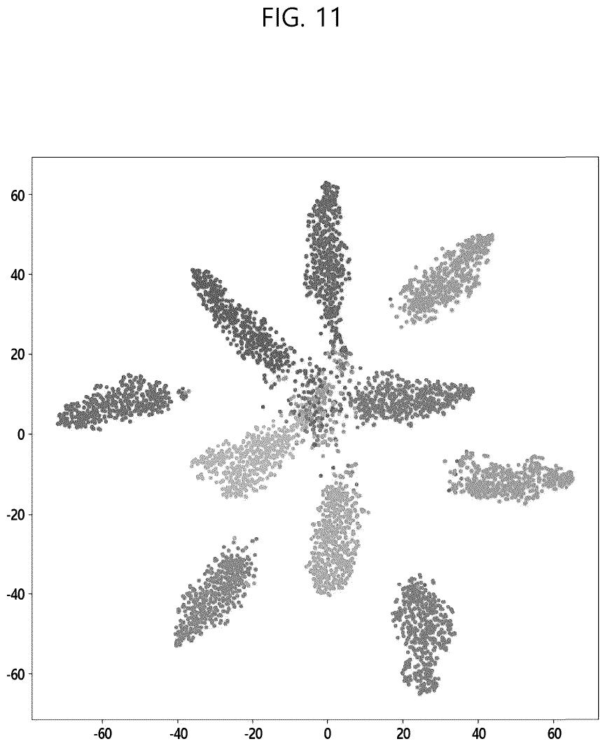

Meanwhile, FIGS. 11 to 13 are graphs showing an example of the learning results of an artificial neural network to which the learning data augmentation method according to the present invention is applied.

FIG. 11 shows that a t-SNE (t-distributed Stochastic Neighbor Embedding) can confirm distribution according to a similarity between feature data extracted from the artificial neural network to which the learning data augmentation method and system are applied.

In other words, it can be confirmed that the artificial neural network to which the learning data augmentation method and system according to the present invention are applied appears to have a narrow form of distribution, which can be understood to show excellent data classification performance of the artificial neural network.

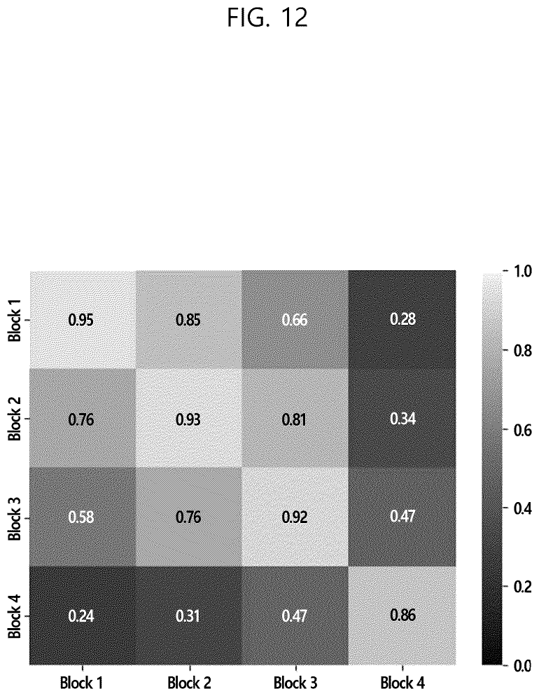

FIG. 12 shows that a CKA (Centered Kernel Alignment) can confirm a similarity between a layer of the artificial neural network to which the learning data augmentation method and system are applied and a layer of the artificial neural network learned using only a low frequency band of the input data.

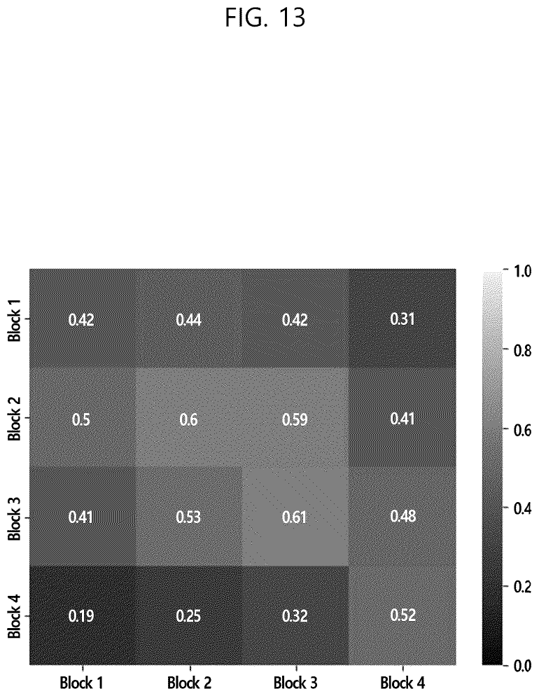

In this case, it can be understood that the closer a value of the graph for the CKA is to 1, the more similar it is, and the closer the value of the graph is to 0, the less similar it is. Further, FIG. 13 shows that the CKA can confirm a similarity between a layer of the artificial neural network to which the learning data augmentation method and system are applied and a layer of the artificial neural network learned using only a high frequency band of the input data.

As such, it can be understood that the artificial neural network learned using only the low frequency band and the artificial neural network learned using only the high frequency band in the learning data augmentation method and system according to the present invention show relatively high similarity, respectively, which makes it possible to perform learning of the artificial neural network through various frequency components.

Furthermore, Table 1 below can confirm a learning accuracy performed by the artificial neural network to which the learning data augmentation method and system according to the present invention are applied.

TABLE 1

| | Top-1 Accuracy in each session (%) | | | | | | | | | |
|---|---|---|---|---|---|---|---|---|---|---|
| Method | 0 | 1 | 2 | 3. | 4 | 5 | 6 | 7 | 8 | PG |
| CEC | 78.00 | 72.89 | 69.01 | 65.45 | 62.36 | 59.09 | 56.42 | 54.28 | 52.63 | 1.14 |
| +FourierAugment | 80.30 | 74.34 | 69.94 | 66.48 | 63.37 | 60.63 | 57.59 | 55.45 | 53.77 | |
| C-FSCIL | 76.40 | 71.14 | 66.46 | 63.29 | 60.42 | 57.46 | 54.78 | 53.11 | 51.41 | 0.73 |
| +FourierAugment | 76.85 | 71.78 | 67.09 | 64.37 | 61.34 | 58.35 | 55.49 | 53.65 | 52.14 | |
| FACT | 75.92 | 70.62 | 66.29 | 62.79 | 59.46 | 56.27 | 53.23 | 51.05 | 49.20 | 4.81 |
| +FourierAugment | 81.25 | 75.86 | 71.50 | 67.68 | 64.50 | 61.05 | 57.84 | 55.82 | 54.01 | |
| ALICE | 81.03 | 72.48 | 68.94 | 65.15 | 62.68 | 60.11 | 57.74 | 56.85 | 55.72 | 0.37 |
| +FourierAugnient | 80.88 | 73.06 | 69.57 | 65.80 | 63.46 | 60.61 | 58.32 | 57.15 | 56.09 | |
| FeSSSS | 81.50 | 77.04 | 72.92 | 69.56 | 67.27 | 64.34 | 62.07 | 60.55 | 58.87 | 2.74 |
| +FourierAugment | 84.41 | 79.80 | 75.87 | 72.44 | 70.32 | 67.29 | 64.24 | 62.97 | 61.61 | |

As described above, it can be confirmed that the learning accuracy for the artificial neural network is improved by the learning data augmentation method and system according to the present invention.

Meanwhile, the learning data augmentation method and system according to the present invention can also be effective for a general image classification model (or an artificial neural network) with a limited resource. Herein, the limited resource refers to a resource suitable for an embedded environment and may include an image classification model with a memory usage of 0.7 GB or less and a calculation time of 17 ms or less.

For example, the image classification model with the limited resource may generally include ResNet18 and EfficientNet-lite0, and verification for learning and learning result according to the learning data augmentation can be performed using each of the image data set of a mini-ImageNet with a relatively small amount of data and an ImageNet with a relatively large amount of data.

Table 2 below shows that the performance verification results for the ResNet18 can be confirmed according to the learning in which the learning data augmentation method (FA) according to the present invention and the existing data augmentation techniques AugMix (AM), RandAugment (RA), and Deep AutoAugment (DAA) are used, respectively, and Table 3 below shows that the performance verification results for the EfficientNet-lite0 can be confirmed according to the learning in which the learning data augmentation method (FA) according to the present invention and the existing data augmentation techniques AugMix (AM), RandAugment (RA), and Deep AutoAugment (DAA) are used, respectively.

TABLE 2

| | miniImageNet | | ImageNet | | |
|---|---|---|---|---|---|
| Method | 100 | 500 | 100 | 500 | full |
| baseline | 35.60 | 61.52 | 19.13 | 57.81 | 65.16 |
| + AM | 34.42 | 58.89 | 36.22 | 59.15 | 67.38 |
| + RA | 35.98 | 61.94 | 22.61 | 51.99 | 67.33 |
| + DAA | 35.81 | 64.30 | 22.23 | 57.68 | 67.50 |
| + FA | 37.35 | 65.23 | 37.26 | 61.44 | 67.82 |

TABLE 3

| | miniImageNet- | miniImageNet- | ImageNet- | ImageNet- |
|---|---|---|---|---|
| Method | 100 | 500 | 100 | 500 |
| baseline | 33.80 | 59.04 | 27.90 | 55.88 |
| + AM | 33.51 | 58.99 | 36.88 | 61.15 |
| + RA | 27.74 | 56.11 | 32.46 | 59.04 |
| + DAA | 26.12 | 54.94 | 35.73 | 60.43 |
| + FA | 34.48 | 59.35 | 36.94 | 61.46 |

Herein, the numbers (e.g., 100 and 500) described for each data set (e.g., mini-ImageNet and ImageNet) may refer to the number of data per a class.

Also, Table 4 below shows that the performance verification results for the data set of mini-ImageNet in the FSCIL-typed artificial neural network can be confirmed according to the learning in which the learning data augmentation method (FA) according to the present invention and the existing data augmentation techniques AugMix (AM), RandAugment (RA), and Deep AutoAugment (DAA) are used, respectively, and Table 5 below shows that the performance verification results for the CUB200 data set in the FSCIL-typed artificial neural network can be confirmed according to the learning in which the learning data augmentation method (FA) according to the present invention and the existing data augmentation techniques AugMix (AM), RandAugment (RA), and Deep AutoAugment (DAA) are used, respectively.

In this case, CEC, FACT, and ALICE may be used as the FSCIL-typed artificial neural network.

TABLE 4

| | Top-1 Accuracy in each session (%) | | | | | | | | | |
|---|---|---|---|---|---|---|---|---|---|---|
| Method | 0 | 1 | 2 | 3 | 4 | 5 | 6 | 7 | 8 | PG |
| CEC | 78.00 | 72.89 | 69.01 | 65.45 | 62.36 | 59.09 | 56.42 | 54.28 | 52.63 | — |
| +AM | 73.45 | 68.46 | 64.06 | 60.59 | 57.41 | 54.32 | 51.40 | 49.32 | 47.42 | −5.21 |
| +RA | 76.80 | 71.62 | 67.17 | 63.83 | 60.54 | 57.51 | 54.90 | 52.93 | 51.36 | −1.27 |
| +DAA | 76.80 | 71.62 | 67.26 | 63.63 | 60.59 | 57.71 | 54.96 | 52.81 | 51.57 | −1.06 |
| +FA | 80.30 | 74.34 | 69.94 | 66.48 | 63.37 | 60.63 | 57.59 | 55.45 | 53.77 | +1.14 |
| FACT | 75.92 | 70.62 | 66.29 | 62.79 | 59.46 | 56.27 | 53.23 | 51.05 | 49.20 | — |
| +AM | 74.73 | 69.68 | 65.14 | 62.01 | 59.08 | 56.29 | 53.52 | 51.72 | 50.00 | +0.80 |
| +RA | 77.47 | 72.22 | 68.10 | 64.45 | 61.37 | 58.64 | 55.49 | 53.58 | 52.02 | +2.97 |
| +DAA | 78.73 | 73.20 | 68.77 | 65.05 | 62.16 | 59.11 | 55.89 | 53.94 | 52.49 | +3.44 |
| +FA | 81.25 | 75.86 | 71.50 | 67.68 | 64.50 | 61.05 | 57.84 | 55.82 | 54.01 | +4.96 |
| ALICE | 81.03 | 72.48 | 68.94 | 65.15 | 62.68 | 60.11 | 57.74 | 56.85 | 55.72 | — |
| +AM | 77.53 | 69.03 | 64.39 | 61.21 | 57.95 | 55.18 | 52.88 | 51.29 | 49.62 | −6.10 |
| +RA | 77.38 | 69.02 | 65.40 | 61.84 | 59.52 | 56.78 | 54.50 | 52.55 | 51.47 | −4.25 |
| +DAA | 76.53 | 67.97 | 64.24 | 60.21 | 57.77 | 55.41 | 53.00 | 51.57 | 50.94 | −4.78 |
| +FA | 80.88 | 73.06 | 69.57 | 65.80 | 63.46 | 60.61 | 58.32 | 57.15 | 56.09 | +0.37 |

TABLE 5

| | Top-1 Accuracy in each session (%) | | | | | | | | | | | |
|---|---|---|---|---|---|---|---|---|---|---|---|---|
| Method | 0 | 1 | 2 | 3 | 4 | 5 | 6 | 7 | 8 | 9 | 10 | PG |
| CEC | 73.85 | 71.94 | 68.50 | 63.50 | 62.43 | 58.27 | 57.73 | 55.81 | 54.83 | 53.52 | 52.28 | — |
| +AM | 74.73 | 70.30 | 66.11 | 60.83 | 60.30 | 55.90 | 54.19 | 52.41 | 51.74 | 49.91 | 48.15 | −4.13 |
| +RA | 73.22 | 69.29 | 64.71 | 60.04 | 59.31 | 55.44 | 54.32 | 51.90 | 51.21 | 49.59 | 48.10 | −4.18 |
| +DAA | 74.15 | 70.06 | 66.08 | 60.88 | 60.00 | 56.59 | 54.95 | 52.69 | 51.52 | 50.24 | 49.09 | −3.19 |
| +FA | 79.94 | 75.22 | 70.89 | 66.05 | 64.79 | 61.37 | 60.27 | 58.20 | 57.22 | 56.31 | 55.09 | +2.81 |
| FACT | 75.90 | 73.23 | 70.84 | 66.13 | 65.56 | 62.15 | 61.74 | 59.83 | 58.41 | 57.89 | 56.94 | — |
| +AM | 79.21 | 74.73 | 71.25 | 66.85 | 66.09 | 63.40 | 62.65 | 61.50 | 59.63 | 58.82 | 57.81 | +0.87 |
| +RA | 79.30 | 75.18 | 71.28 | 66.35 | 66.06 | 62.20 | 60.55 | 59.37 | 58.33 | 57.35 | 56.13 | −0.81 |
| +DAA | 79.97 | 75.90 | 72.43 | 67.09 | 66.55 | 62.93 | 61.08 | 59.87 | 59.00 | 57.56 | 56.14 | −0.80 |
| +FA | 79.80 | 74.30 | 70.88 | 66.58 | 66.27 | 62.77 | 62.61 | 61.44 | 59.13 | 58.92 | 57.87 | +0.93 |
| ALICE | 78.14 | 73.15 | 70.64 | 67.33 | 65.57 | 62.88 | 62.05 | 61.09 | 59.82 | 59.79 | 59.27 | — |
| +AM | 78.46 | 73.91 | 71.22 | 67.97 | 65.91 | 63.06 | 62.25 | 61.41 | 59.70 | 59.56 | 58.92 | −0.35 |
| +RA | 77.48 | 72.89 | 70.61 | 67.06 | 65.09 | 62.07 | 61.34 | 60.40 | 58.95 | 58.81 | 58.25 | −1.02 |
| +DAA | 77.30 | 71.94 | 69.24 | 65.93 | 64.35 | 61.56 | 60.84 | 60.01 | 58.61 | 58.48 | 57.84 | −1.43 |
| +FA | 78.53 | 75.12 | 72.71 | 69.34 | 67.55 | 64.86 | 63.89 | 63.18 | 61.72 | 61.76 | 60.84 | +1.57 |

Furthermore, the present invention as discussed above can be implemented as a computer-readable code or instructions on a program-recorded medium. That is, the various control methods according to the present invention may be provided in either the integrated form or the individual form of a program.

Meanwhile, the computer-readable medium includes all types of recording devices that store data capable of being read by a computer system. An Example of the computer-readable medium includes HDD (Hard Disk Drive), SSD (Solid State Disk), SDD (Silicon Disk Drive), ROM, RAM, CD-ROM, a magnetic tape, a floppy disk, an optical data storage device, etc.

Further, the computer-readable medium may be a server or cloud storage that includes a storage and can be accessed through communication of an electronic device. In this case, the computer can download the program according to the present invention from the server or the cloud storage through a wired or wireless communication.

Furthermore, according to the present invention, the computer as described above is an electronic device equipped with a processor, that is, a CPU (Central Processing Unit), and is not particularly limited on a type thereof.

Meanwhile, the detailed description as explained above should not be construed as restrictive in all respects and should be considered to be for illustration. The scope of the present invention should be determined by reasonable interpretation of the appended claims, and all changes within the equivalent scope of the present invention are included in the scope of the present invention.

What is claimed is:

1. A learning data augmentation method comprising:
receiving a learning target image;
obtaining a frequency spectrum corresponding to the learning target image by applying frequency transformation to the learning target image;
obtaining a plurality of sub-frequency spectra from the frequency spectrum by separating the frequency spectrum according to a plurality of preset frequency bands; and
obtaining a learning data set by applying inverse frequency transformation to each of the plurality of obtained sub-frequency spectra.

2. The learning data augmentation method according to claim 1,
further comprising obtaining a plurality of channel images from the learning target image by separating the learning target image into a plurality of channels according to a plurality of preset color elements,
wherein the obtaining the frequency spectrum comprises obtaining a plurality of channel frequency spectra corresponding to each of the plurality of channel images by applying frequency transformation to each of the plurality of channel images.

3. The learning data augmentation method according to claim 2,
wherein the obtaining the plurality of sub-frequency spectra comprises obtaining the plurality of sub-channel frequency spectra from each of the plurality of channel frequency spectra by separating each of the plurality of channel frequency spectra according to the plurality of frequency bands.

4. The learning data augmentation method according to claim 3,
wherein the obtaining the learning data set comprises obtaining a plurality of learning images from each of the plurality of sub-channel frequency spectra by applying inverse frequency transformation to each of the plurality of obtained sub-channel frequency spectra; and
generating the learning data set to contain the plurality of learning images based on at least one of the learning target image and the plurality of learning images.

5. The learning data augmentation method according to claim 1,
further comprising obtaining a plurality of channel frequency spectra from the frequency spectrum by separating the frequency spectrum into a plurality of channels according to a plurality of preset color elements.

6. The learning data augmentation method according to claim 1,
wherein the obtaining the learning data set comprises matching a label data matched to the learning target image, to the learning data set, if there is the label data matched to the learning target image.

7. The learning data augmentation method according to claim 1,
further comprising learning a pre-prepared artificial neural network to output correct answer data corresponding to a learning image by using the obtained learning data set if the learning image is input.

8. The learning data augmentation method according to claim 7,
wherein in the artificial neural network, at least one hidden layer included to transform the learning target image into 3-dimensional data through channel division for the learning target image is replaced with a layer that acquires the learning data set from the learning target image.

9. A learning data augmentation system comprising:
a storage unit that stores a learning target image; and
a control unit that applies frequency transformation to the learning target image to obtain a frequency spectrum corresponding to the learning target image, separates the frequency spectrum according to a plurality of preset frequency bands to obtain a plurality of sub-frequency spectra from the frequency spectrum, and obtains a learning data set by applying inverse frequency transformation to each of the plurality of obtained sub-frequency spectra.

10. A computer-readable storage medium storing a program executable by one or more processors in an electronic device,
wherein the program comprises instructions that cause the one or more processors to implement a method comprising:
receiving a learning target image;
obtaining a frequency spectrum corresponding to the learning target image by applying frequency transformation to the learning target image;
obtaining a plurality of sub-frequency spectra from the frequency spectrum by separating the frequency spectrum according to a plurality of preset frequency bands; and
obtaining a learning data set by applying inverse frequency transformation to each of the plurality of obtained sub-frequency spectra.
